(19) United States
(12) Patent Application Publication
(10) Pub. No.: US 2024/0405955 A1
(43) Pub. Date: Dec. 5, 2024

(54) INFORMATION ACTIVATION METHOD, TERMINAL, AND NETWORK SIDE DEVICE

(71) Applicant: VIVO MOBILE COMMUNICATION CO., LTD., Dongguan (CN)

(72) Inventors: Yu YANG, Dongguan (CN); Yang SONG, Dongguan (CN); Hao LIU, Dongguan (CN)

(73) Assignee: VIVO MOBILE COMMUNICATION CO., LTD., Dongguan (CN)

(21) Appl. No.: 18/800,201

(22) Filed: Aug. 12, 2024

Related U.S. Application Data
(63) Continuation of application No. PCT/CN2023/075427, filed on Feb. 10, 2023.

(30) Foreign Application Priority Data
Feb. 11, 2022 (CN) 202210129250.X

(51) Int. Cl. H04L 5/00; H04W 72/231; H04W 72/232

(52) U.S. Cl. CPC H04L 5/0094; H04L 5/0035; H04W 72/231; H04W 72/232

(57) ABSTRACT

An information activation method, a network side device and a non-transitory computer-readable storage medium are provided. The information activation method includes: sending, by the network side device, a first Media Access Control Control Element (MAC CE) command. The first MAC CE command is used for activating a Transmission Configuration Indicator (TCI) state. The first MAC CE command includes a plurality of codepoints. At least one codepoint among the plurality of codepoints corresponds to a plurality of TCI states among activated TCI states. The activated TCI states are used for determining common beam information of a plurality of channels.

### CROSS-REFERENCE TO RELATED APPLICATIONS

This application is a continuation of International Application No. PCT/CN2023/075427, filed on Feb. 10, 2023, which claims the priority of Chinese Patent Application No. 202210129250.X filed on Feb. 11, 2022. The entire contents of each of the above-referenced applications are expressly incorporated herein by reference.

### TECHNICAL FIELD

This application belongs to the technical field of communications, and in particular, to an information activation method, a terminal, and a network side device.

### BACKGROUND

After beam measurement and beam reporting are performed, a network can provide beam indications for channels or reference signals of a down link and an up link to establish a beam link between the network and a User Equipment (UE) to achieve transmission of the channels or the reference signals. In a unified Transmission Configuration Indicator (TCI) framework, a network uses the same beam indicated by a Media Access Control Control Element (MAC CE) and/or Downlink Control Information (DCI) for transmission of a plurality of channels, wherein beam information can typically be represented by TCI state information.

At present, using the same beam for transmission of a plurality of channels only supports a single Transmission Reception Point (TRP) scenario. There is no solution yet on how to support a multi-TRP scenario.

### SUMMARY

Embodiments of this application provide an information activation method, a terminal, and a network side device.

In a first aspect, an information activation method is provided. The method includes:

A network side device sends a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and
the activated TCI states are used for determining common beam information of a plurality of channels.

In a second aspect, an information activation apparatus is provided, including:
a sending module, configured to send a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and
the activated TCI states are used for determining common beam information of a plurality of channels.

In a third aspect, an information activation method is provided. The method includes:

A terminal receives a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and
the activated TCI states are used for determining common beam information of a plurality of channels.

In a fourth aspect, an information activation apparatus is provided, including:
a receiving module, configured to receive a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and
the activated TCI states are used for determining common beam information of a plurality of channels.

In a fifth aspect, a network side device is provided. The network side device includes a processor and a memory. The memory stores programs or instructions runnable on the processor, and the programs or instructions, when run by the processor, implement the steps of the method as described in the first aspect.

In a sixth aspect, a network side device is provided, including a processor and a communication interface. The communication interface is used for sending a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels.

In a seventh aspect, a terminal is provided. The terminal includes a processor and a memory. The memory stores programs or instructions runnable on the processor, and the programs or instructions, when run by the processor, implement the steps of the method as described in the third aspect.

In an eighth aspect, a terminal is provided, including a processor and a communication interface. The communication interface is used for receiving a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels.

In a ninth aspect, a communications system is provided, including: a terminal and a network side device. The terminal may be configured to execute the steps of the information activation method as described in the third aspect, and the network side device may be configured to execute the steps of the information activation method as described in the first aspect.

In a tenth aspect, a readable storage medium is provided, having programs or instructions stored thereon. The programs or instructions, when run by a processor, implement the steps of the method as described in the first aspect, or implement the steps of the method as described in the third aspect.

In an eleventh aspect, a chip is provided. The chip includes a processor and a communication interface. The communication interface is coupled with the processor, and the processor is configured to running programs or instructions to implement the steps of the method as described in the first aspect, or implement the steps of the method as described in the third aspect.

In a twelfth aspect, a computer program/program product is provided. The computer program/program product is stored in a storage medium. The computer program/program product is run by at least one processor to implement the steps of the method as described in the first aspect or the third aspect.

In the embodiments of this application, a network side device sends a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels. In the above embodiments, in a multi-TRP scenario, the activated TCI states include TCI states of various TRPs used for transmission of a plurality of channels, so that the same beam on the various TRPs can be used for transmission of the plurality of channels in the multi-TRP scenario.

### BRIEF DESCRIPTION OF THE DRAWINGS

FIG. 1 is a block diagram of a wireless communication system to which an embodiment of this application is applicable;

FIG. 2 is a flowchart I of an information activation method provided by an embodiment of this application;

FIG. 3 is a flowchart II of an information activation method provided by an embodiment of this application;

FIG. 4 is a structural diagram I of an information activation apparatus provided by an embodiment of this application;

FIG. 5 is a structural diagram II of an information activation apparatus provided by an embodiment of this application;

FIG. 6 is a structural diagram of a communication device provided by an embodiment of this application;

FIG. 7 is a structural diagram of a terminal provided by an embodiment of this application; and

FIG. 8 is a structural diagram of a network side device provided by an embodiment of this application.

### DETAILED DESCRIPTION

The technical solutions in embodiments of this application are described in the following with reference to the accompanying drawings in the embodiments of this application. Apparently, the described embodiments are merely some rather than all of the embodiments of this application. All other embodiments obtained by persons skilled in the art based on the embodiments of this application fall within the protection scope of this application.

This specification and claims of this application, and terms “first” and “second” are used to distinguish similar objects, but are unnecessarily used to describe a specific sequence or order. It should be understood that terms used like this is interchangeable where appropriate, so that the embodiments of this application can be implemented in an order other than those illustrated or described here. Furthermore, objects distinguished by “first”, “second”, and the like are usually of the same class and do not limit the number of objects. For example, the first object can be one or multiple. In addition, “and/or” used in this specification and the claims represents at least one of the connected objects. Symbol “/” usually represents an “or” relationship between front and back associated objects.

It is worth noting that the technology described in the embodiments of this application is not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are often used interchangeably, and the described technology can be applied to both the aforementioned systems and radio technologies, as well as other systems and radio technologies. The following describes a New Radio (NR) system for the example purpose and uses the term NR in most of the following descriptions. However, these technologies can also be applied to applications other than the NR system application, such as a 6th Generation (6G) communication system.

FIG. 1 shows a block diagram of a wireless communication system applicable to an embodiment of this application. The wireless communication system includes a terminal 11 and a network side device 12. The terminal 11 can be a mobile phone, a tablet personal computer, a laptop computer or also referred to as a laptop, a Personal Digital Assistant (PDA), a handheld computer, a netbook, Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (home devices with wireless communication functions, such as a refrigerator, a television, a washing machine, or furniture), a game console, a Personal Computer (PC), a teller machine, a vending machine, or other terminal side devices. The wearable device includes: a smart watch, a smart hand ring, a smart headphone, smart glasses, a smart jewelry (a smart bracelet, a smart ring, a smart necklace, a smart bangle, a smart anklet, and the like), a smart wristband, smart clothing, and the like. It should be noted, in the embodiments of this application, a specific type of the terminal 11 is not limited. The network side device 12 may include an access network device or a core network device. The access network device may be referred to as a radio access network device, a Radio Access Network (RAN), a radio access network function, or a radio access network unit. The access network device may include a base station, a Wireless Local Area Networks (WLAN) access point, a Wireless Fidelity (WiFi) node, and the like. The base station can be referred to as a node B, an evolution node B (cNB), an access point, a Base Transceiver Station (BTS), a radio base station, a radio transceiver, a Basic Service Set (BSS), an Extended Service Set (ESS), a home B node, a home eNB, a TRP, or any other suitable term in the art, as long as the same technical effects are achieved. The base station is not limited to a particular technical vocabulary. It should be noted that, in the embodiments of this application, only the base station in the NR system is taken as an example, but a specific type of the base station is not limited. A information activation method provided by an embodiment of this application will be described below through some embodiments and their application scenarios in combination with the accompanying drawings.

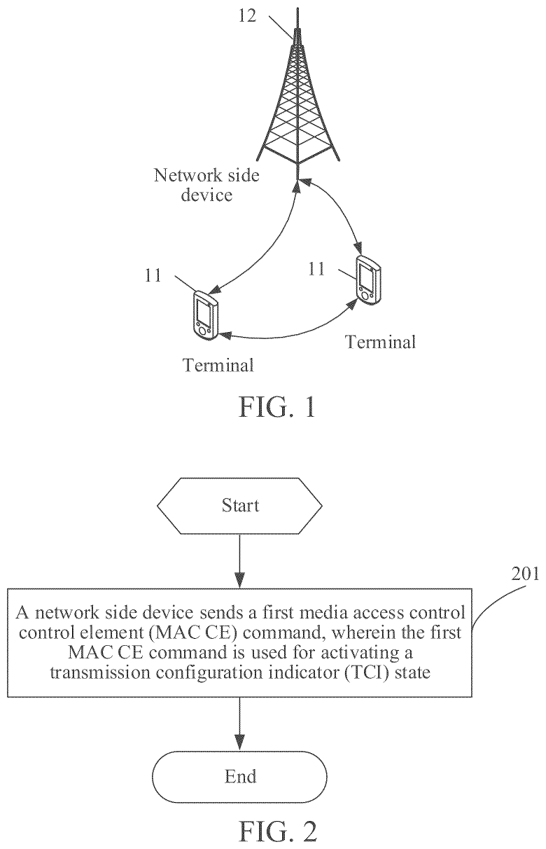

As shown in FIG. 2, an embodiment of this application provides an information activation method, including the following step:

Step 101. A network side device sends a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels.

The information activation method provided by this embodiment of this application is used in a multi-TRP single DCI scenario. For example, TCI codepoints activated by the network side device through an MAC CE command include at least one TCI codepoint corresponding to a plurality of joint TCI states or a plurality of pairs of separate TCI states. At this time, it can be considered that each joint TCI state or each pair of separate TCI states correspond to one TRP. A Control Resource Set (CORESET) Pool Index (CORESETPoolIndex) configured by the network side device in a single DCI scenario through a Radio Resource Control (RRC) signaling is a value, such as 0 or 1, or CORESETPoolIndex is not configured.

The activated TCI states include a target TCI state. The target TCI state is a TCI state used for transmission of a plurality of channels.

In the embodiments of this application, the network side device sends the first MAC CE command. The first MAC CE command is used for activating TCI states. The first MAC CE command includes a plurality of codepoints, and at least one codepoint among the plurality of codepoints corresponds to a plurality of TCI states among the activated TCI state; and the activated TCI states are used for determining common beam information of a plurality of channels. According to the above, in a multi-TRP scenario, the activated TCI states include TCI states of various TRPs used for transmission of a plurality of channels, so that the same beam on the various TRPs can be used for transmission of the plurality of channels in the multi-TRP scenario.

In an embodiment of this application, the activated TCI states correspond to first identification information; and the first identification information includes at least one of the following items:
CORESET identification information;
identification information of correlated Search Spaces (SSs), wherein the correlated SSs are used for repeated transmission of a Physical Downlink Control Channel (PDCCH);
identification information of a CORESET where the correlated SSs are located;
transmission occasion information or transmission time information of the correlated SSs;
CORESETPoolIndex;
TRP identification information;
channel group identification information;
CORESET group identification information;
Physical Uplink Control Channel (PUCCH) resource group identification information;
spatial filter identification information;
terminal panel identification information;
beam identification information; and
TCI state identification information.

According to the above, TRPs corresponding to the activated TCI states can be determined according to the first identification information. One or more TRPs may be determined according to the first identification information. Since the application scenario of this application is a scenario where no TRP Identity Document (ID) (RRC parameter CORESETPoolIndex) is set or a TRP ID value is configured, the first identification information in the embodiments of this application can be used to represent one or more TRPs.

In an embodiment of this application, in a case that the network side device is configured with a joint TCI mode, each TCI state activated according to the first MAC CE command and the codepoints satisfy: one codepoint corresponds to at least one joint TCI state. For example, each joint TCI state is a TCI state corresponding to one piece of the first identification information.

In an embodiment of this application, in a case that the network side device is configured with a separate TCI mode, each TCI state activated according to the first MAC CE command and the codepoints satisfy: one codepoint corresponds to at least one pair of separate TCI states. For example, each pair of separate TCI states may be a TCI state corresponding to one piece of the first identification information.

For example, a pair of separate TCI states includes a separate Downlink (DL) TCI state and a separate Uplink (UL) TCI state.

In an embodiment of this application, in a case that the network side device is configured with a separate TCI mode and a joint TCI mode, each TCI state activated according to the first MAC CE command and the codepoints satisfy one of the following items:
one codepoint corresponds to at least one joint TCI state and at least one pair of separate TCI state. For example, each joint TCI state corresponds to one piece of the first identification information, and each pair of separate TCI states corresponds to one piece of the first identification information.

For example, the first identification information corresponding to each joint TCI state is different from the first identification information corresponding to each pair of separate TCI states. The TRPs determined according to the first identification information corresponding to the joint TCI states are different from the TRPs determined according to the first identification information corresponding to the separate TCI states.

In an embodiment of this application, in a case that there are N pieces of first identification information corresponding to the TCI states activated according to the first MAC CE command, each piece of first identification information corresponds to one joint TCI state, or a pair of separate TCI states, or one separate DL TCI state, or one separate UL TCI state, and a value of N satisfies at least one of the following items:
the value of N is a quantity of TRPs;
the value of N is a quantity of the first identification information corresponding to the TCI states corresponding to all the codepoints in the first MAC CE command; and
the value of N is a maximum quantity of the first identification information corresponding to the joint TCI states or the separate TCI states corresponding to each codepoint in the first MAC CE command.

In an embodiment of this application, the method further includes: The network side device sends target DCI, wherein the target DCI is used for indicating a target TCI state. The target DCI includes a TCI field. The TCI field indicates one codepoint. A TCI state corresponding to the codepoint is the target TCI state.

In an embodiment of this application, the method further includes: The network side device determines Beam Application Time (BAT) of a target TCI state among the activated TCI states. Or, BAT may be referred to as beam application time.

For the target DCI, the BAT is a first slot after Y symbols after the network side device receives response information to the target DCI; the response information is acknowledgment information sent by a terminal based on first information; Y is a positive integer; and the first information is information used for determining the target TCI state.

For example, in a case that all the codepoints in the first MAC CE command correspond to the same joint TCI state or the same pair of separate TCI states, namely, in a case that the first MAC CE command only activates one joint TCI state or one pair of separate TCI states, the joint TCI state or the pair of separate TCI states is the target TCI state, and the network side device does not need to indicate the target TCI state through the target DCI. In this case, the first MAC CE command is information used for determining the target TCI state. The first information is the first MAC CE command. The response information is acknowledgment information sent by a terminal based on the first MAC CE command.

In a case that there are a plurality of joint TCI states or a plurality of pairs of separate TCI states corresponding to all the codepoints in the first MAC CE command, namely, in a case that the first MAC CE command activates a plurality of joint TCI states or a plurality of pairs of separate TCI states, the network side device needs to indicate the target TCI state through the DCI. In this case, the target DCI is information used for determining the target TCI state. The first information is the target DCI. The response information is acknowledgment information sent by a terminal based on the target DCI.

In an embodiment of this application, the target TCI state is a TCI state activated by the network side device through the first MAC CE command, or a TCI state indicated through DCI; a first TCI state is a TCI state last activated by the network side device through an MAC CE before determining the target TCI state, or a TCI state indicated through the DCI; and
correspondingly, the network side device determines BAT of a target TCI state among the activated TCI states, which includes: The network side device determines the BAT of the target TCI state according to the target TCI state and the first TCI state.

According to the above, there are situations for the target TCI state: In one situation, in a case that the first MAC CE command only activates one joint TCI state or one pair of separate TCI states, the joint TCI state or the pair of separate TCI states is the target TCI state, and the network side device does not need to indicate the target TCI state through the target DCI. In the other situation, in a case that the first MAC CE command activates a plurality of joint TCI state or a plurality of pairs of separate TCI states, the network side device needs to indicate the target TCI state through the target DCI.

Correspondingly, there are two situations for the first TCI state as well: In one situation, in a case that only one joint TCI state or one pair of separate TCI states is activated at the last time through an MAC CE command, the joint TCI state or the pair of separate TCI states is the first TCI state. In the other situation, in a case that a plurality of joint TCI states or a plurality of pairs of separate TCI states are activated at the last time through an MAC CE command, the network side device needs to indicate the first TCI state through DCI. The network side device determines the BAT of the target TCI state according to the two TCI states.

In an implementation, the first TCI state corresponds to a first codepoint, and the target TCI state corresponds to a second codepoint.

In a case that the first TCI state and the target TCI state satisfy at least one of the following items, the network side device determines the BAT of the target TCI state:
(1) The TCI states corresponding to the first codepoint are different from the TCI states corresponding to the second codepoint, for example, the TCI states corresponding to the first codepoint are subsets of the TCI states corresponding to the second codepoint; or, the TCI states corresponding to the second codepoint are subsets of the TCI states corresponding to the first codepoint.
(2) TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; and
(3) TCI states corresponding to the first codepoint are the same as TCI states corresponding to the second codepoint, and arrangement positions of the TCI states corresponding to the first codepoint are different from arrangement positions of the TCI states corresponding to the second codepoint. For example, the first codepoint corresponds to {TCI state1, TCI state2}, and the second codepoint corresponds to {TCI state2, TCI state1}. At this time, the two codepoints correspond to TCI state1 and TCI state2, but the sequences or positions of the TCI states corresponding to the two codepoints are different.

In an embodiment of this application, the first MAC CE command includes a first signaling field, and the first signaling field is used for indicating a target TCI state from the TCI states activated by the first MAC CE command;
or, the target DCI includes a first signaling field, and the first signaling field is used for indicating a target TCI state from TCI states corresponding to codepoints indicated by a TCI field in the target DCI.

According to the above, whether the first MAC CE command includes the first signaling field is determined according to at least one of the following items:
configuration information of the network side device; and
a quantity of the TCI states activated by the first MAC CE command; and
or, whether the target DCI includes the first signaling field is determined according to at least one of the following items:
configuration information of the network side device; and
a quantity of the TCI states activated by the first MAC CE command; and
a quantity of TCI states corresponding to codepoints indicated by a TCI field in the target DCI.

According to the above, in a case that the first MAC CE includes the first signaling field, the first signaling field is used for indicating one of the following items:
a joint TCI state in the TCI states activated by the first MAC CE command, or a pair of separate TCI states, or a separate UL TCI state, or a separate DL TCI state;
all the TCI states activated by the first MAC CE command; and
all the TCI states activated by the first MAC CE command, and orders or positions of the various TCI states.

Or, in a case that the target DCI includes the first signaling field, the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; and
all the TCI states corresponding to the codepoints indicated by the TCI field in the target DCI, and orders and positions of the various TCI states.

In an embodiment of this application, the target DCI is UL DCI used for indicating a TCI state from the activated TCI states activated by the first MAC CE command. The first signaling field is a Sounding Reference Signal (SRS) Resource Indicator (SRI) field in the UL DCI. The UL DCI is UL DCI for scheduling uplink transmission, or UL DCI without uplink scheduling.

In an embodiment of this application, the target TCI state includes a plurality of joint TCI states, and in a case that the plurality of joint TCI states are all associated with or contain uplink power control parameters, a TRP mode is determined as a multi-TRP scenario;
or, the target TCI state includes a plurality of separate UL TCI states, and in a case that the plurality of separate UL TCI states are all associated with or contain uplink power control parameters, a TRP mode is determined as a multi-TRP scenario;
or, in a case that a quantity of TRPs corresponding to the target TCI state indicated by the first signaling field is greater than one, a TRP mode is determined as a multi-TRP scenario;
or, in a case that a quantity of first identification information corresponding to the target TCI state indicated by the first signaling field is greater than one, a TRP mode is determined as a multi-TRP scenario, wherein the activated TCI states correspond to the first identification information.

The uplink power control parameters include a Path Loss Reference Signal (PLRS), P0, alpha, close loop index, and the like. In a multi-TRP scenario, a terminal uses a target TCI state to transmit an uplink channel, and a network side device can schedule a multi-TRP Physical Uplink Shared Channel (PUSCH) or PUCCH.

In an embodiment of this application, the target TCI state includes a plurality of joint TCI states, and in a case that only one of the plurality of joint TCI states is associated with or contains uplink power control parameters, a TRP mode is determined as a single TRP scenario;
or, the target TCI state includes a plurality of separate UL TCI states, and in a case that only one of the plurality of separate UL TCI states is associated with or contains uplink power control parameters, a TRP mode is determined as a single TRP scenario;
or, in a case that a quantity of TRPs corresponding to the target TCI state indicated by the first signaling field is one, a TRP mode is determined as a single TRP scenario;
or, in a case that a quantity of first identification information corresponding to the target TCI state indicated by the first signaling field is one, a TRP mode is determined as a single TRP scenario, wherein the activated TCI states correspond to the first identification information.

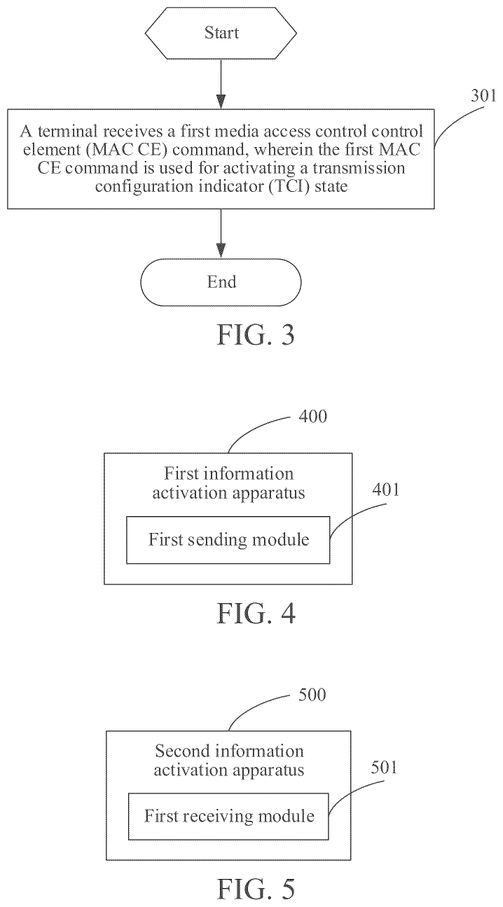

As shown in FIG. 3, an embodiment of this application provides an information activation method, including the following step:

Step 301. A terminal receives a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels.

The information activation method provided by this embodiment of this application is used in a multi-TRP single DCI scenario. For example, TCI codepoints activated by the network side device through an MAC CE command include at least one TCI codepoint corresponding to a plurality of joint TCI states or a plurality of pairs of separate TCI states. At this time, it can be considered that each joint TCI state or each pair of separate TCI states correspond to one TRP. A CORESETPoolIndex configured by the network side device in a single DCI scenario through an RRC signaling is a value, such as 0 or 1, or CORESETPoolIndex is not configured.

The activated TCI states include a target TCI state. The target TCI state is a TCI state used for transmission of a plurality of channels.

In the embodiments of this application, the terminal receives the first MAC CE command. The first MAC CE command is used for activating TCI states. The first MAC CE command includes a plurality of codepoints, and at least one codepoint among the plurality of codepoints corresponds to a plurality of TCI states among the activated TCI state; and the activated TCI states are used for determining common beam information of a plurality of channels. According to the above, in a multi-TRP scenario, the activated TCI states include TCI states of various TRPs used for transmission of a plurality of channels, so that the same beam on the various TRPs can be used for transmission of the plurality of channels in the multi-TRP scenario.

The information activation method in the embodiments of this application can be applied to a scenario configured with no TRPs. Through the method, in the scenario configured with no TRPs, use of the same beam for transmission of the plurality of channels in the multi-TRP single DCI scenario can be achieved.

In an embodiment of this application, the activated TCI states correspond to first identification information; and the first identification information includes at least one of the following items:
CORESET identification information;
identification information of correlated SSs, wherein the correlated SSs are used for repeated transmission of a PDCCH;
identification information of a CORESET where the correlated SSs are located;
transmission occasion information or transmission time information of the correlated SSs;
CORESETPoolIndex;
TRP identification information;
channel group identification information;
CORESET group identification information;
PUCCH resource group identification information;
spatial filter identification information;
terminal panel identification information;
beam identification information; and
TCI state identification information.

In an embodiment of this application, in a case that the network side device is configured with a joint TCI mode, each TCI state activated according to the first MAC CE command and the codepoints satisfy: one codepoint corresponds to at least one joint TCI state. For example, each joint TCI state is a TCI state corresponding to one piece of the first identification information.

In an embodiment of this application, in a case that the network side device is configured with a separate TCI mode, each TCI state activated according to the first MAC CE command and the codepoints satisfy: one codepoint corresponds to at least one pair of separate TCI states. For example, each pair of separate TCI states is a TCI state corresponding to one piece of the first identification information.

In an embodiment of this application, in a case that the network side device is configured with a separate TCI mode and a joint TCI mode, each TCI state activated according to the first MAC CE command and the codepoints satisfy one of the following items:
one codepoint corresponds to at least one joint TCI state and at least one pair of separate TCI state. For example, each joint TCI state corresponds to one piece of the first identification information, and each pair of separate TCI states corresponds to one piece of the first identification information.

In an embodiment of this application, in a case that there are N pieces of first identification information corresponding to the TCI states activated according to the first MAC CE command, each piece of first identification information corresponds to one joint TCI state, or a pair of separate TCI states, or one separate DL TCI state, or one separate UL TCI state, and a value of N satisfies at least one of the following items:
the value of N is a quantity of TRPs;
the value of N is a quantity of the first identification information corresponding to the TCI states corresponding to all the codepoints in the first MAC CE command; and
the value of N is a maximum quantity of the first identification information corresponding to the joint TCI states or the separate TCI states corresponding to each codepoint in the first MAC CE command.

In an embodiment of this application, the method further includes: The terminal receives target DCI, wherein the target DCI is used for indicating a target TCI state.

In an embodiment of this application, the method further includes: The terminal determines BAT of a target TCI state among the activated TCI states.

In an embodiment of this application, the target TCI state is a TCI state activated through the first MAC CE command, or a TCI state indicated through DCI;
a first TCI state is a TCI state last activated through an MAC CE before determining the target TCI state, or a TCI state indicated through the DCI; and
the method further includes: The terminal determines the BAT of the target TCI state according to the target TCI state and the first TCI state.

In an embodiment of this application, the BAT is a first slot after Y symbols after the terminal sends response information; the response information is acknowledgment information sent by a terminal based on first information; Y is a positive integer; and the first information is information used for determining the target TCI state.

In an embodiment of this application, the first TCI state corresponds to a first codepoint, and the target TCI state corresponds to a second codepoint;
in a case that the first TCI state and the target TCI state satisfy at least one of the following items, the terminal determines the BAT of the target TCI state;
TCI states corresponding to the first codepoint are different from TCI states corresponding to the second codepoint;
TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; and
TCI states corresponding to the first codepoint are the same as TCI states corresponding to the second codepoint, and arrangement positions of the TCI states corresponding to the first codepoint are different from arrangement positions of the TCI states corresponding to the second codepoint.

In an embodiment of this application, TCI states corresponding to the first codepoint are different from TCI states corresponding to the second codepoint, which includes:
the TCI states corresponding to the first codepoint are different from the TCI states corresponding to the second codepoint, and the TCI states corresponding to the first codepoint are subsets of the TCI states corresponding to the second codepoint; or,
the TCI states corresponding to the first codepoint are different from the TCI states corresponding to the second codepoint, and the TCI states corresponding to the second codepoint are subsets of the TCI states corresponding to the first codepoint.

In an embodiment of this application, the first MAC CE command includes a first signaling field, and the first signaling field is used for indicating a target TCI state from the TCI states activated by the first MAC CE command.

In an embodiment of this application, the target DCI includes a first signaling field, and the first signaling field is used for indicating a target TCI state from TCI states corresponding to codepoints indicated by a TCI field in the target DCI.

In an embodiment of this application, whether the first MAC CE command includes the first signaling field is determined according to at least one of the following items:
configuration information of the network side device; and
a quantity of the TCI states activated by the first MAC CE command.

In an embodiment of this application, whether the target DCI includes the first signaling field is determined according to at least one of the following items:
configuration information of the network side device;
a quantity of the TCI states activated by the first MAC CE command; and
a quantity of TCI states corresponding to codepoints indicated by a TCI field in the target DCI.

In an embodiment of this application, the first signaling field is used for indicating one of the following items:
a joint TCI state in the TCI states activated by the first MAC CE command, or a pair of separate TCI states, or a separate UL TCI state, or a separate DL TCI state;
all the TCI states activated by the first MAC CE command; and
all the TCI states activated by the first MAC CE command, and orders or positions of the various TCI states.

In an embodiment of this application, the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; and
all the TCI states corresponding to the codepoints indicated by the TCI field in the target DCI, and orders and positions of the various TCI states.

In an embodiment of this application, the target DCI is UL DCI. The first signaling field is an SRS resource set indicator field in the UL DCI. The UL DCI is UL DCI for scheduling uplink transmission, or UL DCI without uplink scheduling.

In an embodiment of this application, the target TCI state includes a plurality of joint TCI states, and in a case that the plurality of joint TCI states are all associated with or contain uplink power control parameters, a TRP mode is determined as a multi-TRP scenario;
or, the target TCI state includes a plurality of separate UL TCI states, and in a case that the plurality of separate UL TCI states are all associated with or contain uplink power control parameters, a TRP mode is determined as a multi-TRP scenario;
or, in a case that a quantity of TRPs corresponding to the target TCI state indicated by the first signaling field is greater than one, a TRP mode is determined as a multi-TRP scenario;
or, in a case that a quantity of first identification information corresponding to the target TCI state indicated by the first signaling field is greater than one, a TRP mode is determined as a multi-TRP scenario, wherein the activated TCI states correspond to the first identification information.

In an embodiment of this application, the target TCI state includes a plurality of joint TCI states, and in a case that only one of the plurality of joint TCI states is associated with or contains uplink power control parameters, a TRP mode is determined as a single TRP scenario;
or, the target TCI state includes a plurality of separate UL TCI states, and in a case that only one of the plurality of separate UL TCI states is associated with or contains uplink power control parameters, a TRP mode is determined as a single TRP scenario;
or, in a case that a quantity of TRPs corresponding to the target TCI state indicated by the first signaling field is one, a TRP mode is determined as a single TRP scenario;
or, in a case that a quantity of first identification information corresponding to the target TCI state indicated by the first signaling field is one, a TRP mode is determined as a single TRP scenario, wherein the activated TCI states correspond to the first identification information.

The information activation method performed by the terminal and the information activation method performed by the network side device have the same technical features. For details, refer to the descriptions in the embodiments of the network side device, and it will not be elaborated here.

The information activation method provided by this application will be illustrated below.

In a case that a network side device is configured with a joint TCI mode and/or a separate TCI mode:

(1) The network side device uses an MAC CE command to activate TCI states:

(11) In a case of configuring the joint TCI mode, each codepoint corresponds to one or more TCI states, wherein each TCI state is a joint TCI state of a TRP.

For example, a codepoint corresponds to {joint TCI state 1 and/or joint TCI state 2, . . . }.

(12) In a case of configuring the separate TCI mode, each codepoint corresponds to one or more pairs of TCI states, wherein each pair of TCI states is a separate TCI state of a TRP.

For example, a codepoint corresponds to {DL TCI state 1, UL TCI state 1, and/or DL TCI state 2, UL TCI state 2, . . . }.

(13) In a case of configuring the joint TCI mode and the separate TCI mode, each codepoint corresponds to one or more joint TCI states, and one or more pairs of separate TCI states.

(14) For example, in a case that in an MAC CE activation command, all codepoints correspond to only one joint TCI state, or only one pair of separate TCI states, this can be determined as a single TRP scenario.

(15) For example, in an MAC CE activation command, a network can always activate N joint TCI states, N pairs of separate TCI states, or N1 separate DL TCI states and N2 separate UL TCI states.

N may be a quantity of TRPs, or N may be a maximum quantity of TCI states corresponding to each codepoint.

N1 represents a maximum quantity of DL TCI states corresponding to each codepoint, and N2 represents a maximum quantity of UL TCI states corresponding to each codepoint.

(2) The network side device indicates a TCI state. The network side device uses first DCI to indicate a target TCI state from the TCI states activated by the MAC CE. Namely, a TCI field in the first DCI indicates one codepoint, and a TCI state corresponding to the codepoint is the target TCI state.

(21) Beam application time of the TCI state indicated by the first DCI and/or whether the scenario is a single TRP scenario or a multi-TRP scenario is determined according to whether the TCI state corresponding to the codepoint indicated at the last time by the network side device is the same as the TCI state corresponding to the codepoint indicated by the first DCI.

(211) BAT is always required, which means that after the first DCI indicates the TCI state, the TCI state indicated by the first DCI starts to be applied from a first slot after Y symbols after ACK of the first DCI.

(212) In a case that TCI states corresponding to new and old codepoints are the same, the new codepoint means a TCI codepoint indicated in the first DCI, and the old codepoint means a TCI codepoint indicated in the previous DCI:

a) In a case that the TCI states corresponding to the new and old codepoints are the same, orders or positions of the TCI states corresponding to the new and old codepoints may be different. For example, the old codepoint corresponds to {TCI state1, TCI state2}, and the new codepoint corresponds to {TCI state2, TCI state1}. At this time, it can be considered that the TCI states corresponding to the two codepoints are the same, and beam switching will not be performed, so that BAT does not need to be determined.

Or, in a case that the orders or positions of the TCI states corresponding to the new and old codepoints are different, for example, in a case that TCI states of two TRPs are exchanged in two adjacent TCI state indications, when the network indicates the old codepoint, TRP1 is TCI state1 and TRP2 is TCI state2; and when the network indicates the new codepoint, TRP1 is TCI state2 and TRP2 is TCI state1. Each TRP needs to perform beam switching. At this time, it can be considered that BAT needs to be determined. The two TRPs perform the beam switching after the BAT.

b) In a case that the orders or positions of the TCI states corresponding to the new and old codepoints are the same, beam switching does not need to be performed, so that BAT is not required.

(213) In a case that the TCI state corresponding to the new codepoint is a subset of the TCI state corresponding to the old codepoint, for example, in a case that the old codepoint corresponds to {TCI state1, TCI state2}, and the new codepoint corresponds to {TCI state 1}:
a) Since TCI state1 is in use all the time, beam switching does not need to be performed, and BAT is not required.
b) In the TCI state corresponding to the old codepoint, all other TCI states except for the TCI state corresponding to the new codepoint are still used, or are no longer used. TCI state2 in the above example may continue to be used or be no longer used.
c) It may still be the multi-TRP scenario. For example, the new codepoint indicated by the network corresponding to TCI state1, but TCI state2 corresponding to the old codepoint is still used. At this time, two TCI states are still used, so that the scenario is a multi-beam transmission scenario. Each TRP uses one TCI state.
d) The multi-TRP scenario may be switched to a single TRP scenario. For example, the new codepoint indicated by the network corresponds to TCI state1, but TCI state2 corresponding to the old codepoint is no longer used. At this time, only one TCI state is used, so that the scenario is a single-beam transmission scenario.

(214) In a case that the TCI state corresponding to the old codepoint is a subset of the TCI state corresponding to the new codepoint, for example, in a case that the old codepoint corresponds to {TCI state1}, and the new codepoint corresponds to {TCI state1, TCI state2}:
a) Since TCI state2 is not previously used, BAT is required to determine application time of TCI state2 corresponding to the new codepoint, namely, TCI state2 will be applied after the BAT.
b) In a case that the network side device has previously indicated the TCI state corresponding to the new codepoint within a preset duration before indicating the old codepoint, BAT may not be required. Namely, TCI state2 corresponding to the new codepoint has been used within the preset duration. Although the old codepoint does not correspond to TCI state2, it can be considered that beam switching does not need to be performed, and a beam corresponding to TCI state2 is still standby and tracked.
c) The single TRP scenario is switched to the multi-TRP scenario. Namely, a single-beam transmission scenario determined by TCI state1 corresponding to the old codepoint is switched to a multi-beam transmission scenario determined by TCI state1 and TCI state2 corresponding to the new codepoint. Each TRP uses one TCI state.

(215) The above example is based on a joint TCI. In case of separate TCI, one joint TCI state in the example is replaced with a pair of separate TCI states.

Further, a first signaling field is introduced into the DCI. The first signaling field is used for indicating at least one of the following:
one joint TCI state or a pair of separate TCI states among TCI states corresponding to codepoints indicated by a TCI field;
all TCI states corresponding to codepoints indicated by a TCI field; and
all TCI states corresponding to codepoints indicated by a TCI field, and orders and positions of the TCI states.

Whether the first signaling field exists or is ignored is determined according to one of the following items:
a configuration of the network side device:
in a case that the MAC CE activates one joint TCI state or one pair of separate TCI states, the network side device configures that no first signaling field exists in the DCI; and
in a case that the MAC CE activates one joint TCI state or one pair of separate TCI states, a UE ignores or does not interpret the first signaling field (even if the first signaling field exists).

Further, the first DCI is UL DCI used for indicating a TCI state from the TCI states activated by the MAC CE; and
reusing an SRS resource set indicator field in the UL DCI. Features of the field are the same as those described in the first signaling field.

The first DCI may be UL DCI for scheduling uplink transmission, or UL DCI without uplink scheduling.

For example, a TRP mode is determined according to a quantity of TCI states, associated with or containing PC parameters (at least one of PLRS, setting {P0, alpha, closeloopindex}), among TCI states indicated by the network side device:

(1) In a case that the network side device indicates a plurality of joint TCI states or separate UL TCI states, and these TCI states are all associated with or contain PC parameters:
a quantity of TRPs (single TRP, or multi-TRP) corresponding to UL transmission may be dynamically indicated through the first signaling field in the UL DCI;
or, it is considered that the scenario is a multi-TRP scenario at this time, and a UE uses the plurality of TCI states to transmit uplink channels (the network side device may schedule a multi-TRP PUSCH or PUCCH).

(2) In a case that the network side device indicates a plurality of joint TCI states or separate UL TCI states, and only one TCI state is associated with or contains PC parameters, it is considered that the scenario is a single TRP scenario, and a UE uses the TCI state to transmit uplink channels (the network side device may only schedule a single-TRP PUSCH or PUCCH).

The information activation method of this application can implement a scheme of applying a unified TCI framework in a multi-TRP scenario. The network can achieve multi-TRP common beams in single DCI and multi-DCI scenarios. Furthermore, through a beam indication scheme, switching between a single TRP scenario and a multi-TRP scenario and selection of TRPs can be further supported. A unified TCI scheme of the multi-TRP scenario can be perfectly and flexibly supported.

An executive body of the information activation method provided by the embodiments of this application may be an information activation apparatus. In the embodiments of this application, using the information activation apparatus to perform the information activation method is taken as an example to explain the information activation apparatus provided by the embodiments of this application.

As shown in FIG. 4, the embodiments of this application provide an information activation apparatus. A first information activation apparatus 400 includes:
a first sending module 401, configured to send a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels.

Further, the activated TCI states correspond to first identification information; and the first identification information includes at least one of the following items:
CORESET identification information;
identification information of correlated SSs, wherein the correlated SSs are used for repeated transmission of a PDCCH;
identification information of a CORESET where the correlated SSs are located;
transmission occasion information or transmission time information of the correlated SSs;
CORESETPoolIndex;
TRP identification information;
channel group identification information;
CORESET group identification information;
PUCCH resource group identification information;
spatial filter identification information;
terminal panel identification information;
beam identification information; and
TCI state identification information.

Further, in a case that the network side device is configured with a joint TCI mode, each TCI state activated according to the first MAC CE command and the codepoints satisfy:
one codepoint corresponds to at least one joint TCI state. For example, each joint TCI state is a TCI state corresponding to one piece of the first identification information.

Further, in a case that the network side device is configured with a separate TCI mode, each TCI state activated according to the first MAC CE command and the codepoints satisfy:
one codepoint corresponds to at least one pair of separate TCI states. For example, each pair of separate TCI states is a TCI state corresponding to one piece of the first identification information.

Further, in a case that the network side device is configured with a separate TCI mode and a joint TCI mode, each TCI state activated according to the first MAC CE command and the codepoints satisfy one of the following items:
one codepoint corresponds to at least one joint TCI state and at least one pair of separate TCI state. For example, each joint TCI state corresponds to one piece of the first identification information, and each pair of separate TCI states corresponds to one piece of the first identification information.

Further, in a case that there are N pieces of first identification information corresponding to the TCI states activated according to the first MAC CE command, each piece of first identification information corresponds to one joint TCI state, or a pair of separate TCI states, or one separate DL TCI state, or one separate UL TCI state, and a value of N satisfies at least one of the following items:
the value of N is a quantity of TRPs;
the value of N is a quantity of the first identification information corresponding to the TCI states corresponding to all the codepoints in the first MAC CE command; and
the value of N is a maximum quantity of the first identification information corresponding to the joint TCI states or the separate TCI states corresponding to each codepoint in the first MAC CE command.

Further, the apparatus 400 further includes a second sending module, configured to send target DCI, wherein the target DCI is used for indicating a target TCI state.

Further, the apparatus 400 further includes a determining module, configured to determine BAT of a target TCI state among the activated TCI states.

Further, the target TCI state is a TCI state activated by the network side device through the first MAC CE command, or a TCI state indicated through DCI;
a first TCI state is a TCI state last activated by the network side device through an MAC CE before determining the target TCI state, or a TCI state indicated through the DCI; and
the determining module is configured to: determine the BAT of the target TCI state according to the target TCI state and the first TCI state.

Further, the BAT is a first slot after Y symbols after the network side device receives response information; the response information is acknowledgment information sent by a terminal based on first information; Y is a positive integer; and the first information is information used for determining the target TCI state.

Further, the first TCI state corresponds to a first codepoint, and the target TCI state corresponds to a second codepoint;

In a case that the first TCI state and the target TCI state satisfy at least one of the following items, the network side device determines the BAT of the target TCI state:
TCI states corresponding to the first codepoint are different from TCI states corresponding to the second codepoint;
TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; and
TCI states corresponding to the first codepoint are the same as TCI states corresponding to the second codepoint, and arrangement positions of the TCI states corresponding to the first codepoint are different from arrangement positions of the TCI states corresponding to the second codepoint.

Further, TCI states corresponding to the first codepoint are different from TCI states corresponding to the second codepoint, which includes:
the TCI states corresponding to the first codepoint are different from the TCI states corresponding to the second codepoint, and the TCI states corresponding to the first codepoint are subsets of the TCI states corresponding to the second codepoint; or,
the TCI states corresponding to the first codepoint are different from the TCI states corresponding to the second codepoint, and the TCI states corresponding to the second codepoint are subsets of the TCI states corresponding to the first codepoint.

Further, the first MAC CE command includes a first signaling field, and the first signaling field is used for indicating a target TCI state from the TCI states activated by the first MAC CE command;

Further, the target DCI includes a first signaling field, and the first signaling field is used for indicating a target TCI state from TCI states corresponding to codepoints indicated by a TCI field in the target DCI.

Further, whether the first MAC CE command includes a first signaling field is determined according to at least one of the following items:
configuration information of the network side device;
a quantity of the TCI states activated by the first MAC CE command.

Further, whether the target DCI includes the first signaling field is determined according to at least one of the following items:
configuration information of the network side device;
a quantity of the TCI states activated by the first MAC CE command; and
a quantity of TCI states corresponding to codepoints indicated by a TCI field in the target DCI.

Further, the first signaling field is used for indicating one of the following items:
a joint TCI state in the TCI states activated by the first MAC CE command, or a pair of separate TCI states, or a separate UL TCI state, or a separate DL TCI state;
all the TCI states activated by the first MAC CE command; and
all the TCI states activated by the first MAC CE command, and orders or positions of the various TCI states.

Further, the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; and
all the TCI states corresponding to the codepoints indicated by the TCI field in the target DCI, and orders and positions of the various TCI states.

Further, the target DCI is UL DCI.

Further, the first signaling field is an SRS resource set indicator field in the UL DCI.

Further, the UL DCI is UL DCI for scheduling uplink transmission, or UL DCI without uplink scheduling.

Further, the target TCI state includes a plurality of joint TCI states, and in a case that the plurality of joint TCI states are all associated with or contain uplink power control parameters, a TRP mode is determined as a multi-TRP scenario;
or, the target TCI state includes a plurality of separate UL TCI states, and in a case that the plurality of separate UL TCI states are all associated with or contain uplink power control parameters, a TRP mode is determined as a multi-TRP scenario;
or, in a case that a quantity of TRPs corresponding to the target TCI state indicated by the first signaling field is greater than one, a TRP mode is determined as a multi-TRP scenario;
or, in a case that a quantity of first identification information corresponding to the target TCI state indicated by the first signaling field is greater than one, a TRP mode is determined as a multi-TRP scenario, wherein the activated TCI states correspond to the first identification information.

Further, the target TCI state includes a plurality of joint TCI states, and in a case that only one of the plurality of joint TCI states is associated with or contains uplink power control parameters, a TRP mode is determined as a single TRP scenario;
or, the target TCI state includes a plurality of separate UL TCI states, and in a case that only one of the plurality of separate UL TCI states is associated with or contains uplink power control parameters, a TRP mode is determined as a single TRP scenario;
or, in a case that a quantity of TRPs corresponding to the target TCI state indicated by the first signaling field is one, a TRP mode is determined as a single TRP scenario;
or, in a case that a quantity of first identification information corresponding to the target TCI state indicated by the first signaling field is one, a TRP mode is determined as a single TRP scenario, wherein the activated TCI states correspond to the first identification information.

The first information activation apparatus 400 provided in the embodiments of this application can implement the various processes implemented by the method embodiment shown in FIG. 2 and achieve the same technical effects. To avoid repetition, details are not described here again.

As shown in FIG. 5, the embodiments of this application provide an information activation apparatus. A second information activation apparatus 500 includes:
a first receiving module 501, configured to receive a first MAC CE command, wherein the first MAC CE command is used for activating a TCI state; and
the activated TCI states are used for determining common beam information of a plurality of channels.

Further, the activated TCI states correspond to first identification information; and the first identification information includes at least one of the following items:
CORESET identification information;
identification information of correlated SSs, wherein the correlated SSs are used for repeated transmission of a PDCCH;
identification information of a CORESET where the correlated SSs are located;
transmission occasion information or transmission time information of the correlated SSs;
CORESETPoolIndex;

TRP identification information;
channel group identification information;
CORESET group identification information;
PUCCH resource group identification information;
spatial filter identification information;
terminal panel identification information;
beam identification information; and
TCI state identification information.

Further, in a case that the network side device is configured with a joint TCI mode, each TCI state activated according to the first MAC CE command and the codepoints satisfy:
one codepoint corresponds to at least one joint TCI state, wherein each joint TCI state is a TCI state corresponding to one piece of the first identification information.

Further, in a case that the network side device is configured with a separate TCI mode, each TCI state activated according to the first MAC CE command and the codepoints satisfy:
one codepoint corresponds to at least one pair of separate TCI states, wherein each pair of separate TCI states is a TCI state corresponding to one piece of the first identification information.

Further, in a case that the network side device is configured with a separate TCI mode and a joint TCI mode, each TCI state activated according to the first MAC CE command and the codepoints satisfy one of the following items:
one codepoint corresponds to at least one joint TCI state and at least one pair of separate TCI states, wherein each joint TCI state corresponds to one piece of the first identification information, and each pair of separate TCI states corresponds to one piece of the first identification information.

Further, in a case that there are N pieces of first identification information corresponding to the TCI states activated according to the first MAC CE command, each piece of first identification information corresponds to one joint TCI state, or a pair of separate TCI states, or one separate DL TCI state, or one separate UL TCI state, and a value of N satisfies at least one of the following items:
the value of N is a quantity of TRPs;
the value of N is a quantity of the first identification information corresponding to the TCI states corresponding to all the codepoints in the first MAC CE command; and
the value of N is a maximum quantity of the first identification information corresponding to the joint TCI states or the separate TCI states corresponding to each codepoint in the first MAC CE command.

Further, the apparatus 500 further includes a second receiving module, configured to receive target DCI, wherein the target DCI is used for indicating a target TCI state.

Further, the apparatus 500 further includes a determining module, configured to determine BAT of a target TCI state among the activated TCI states.

Further, the target TCI state is a TCI state activated through the first MAC CE command, or a TCI state indicated through DCI;
a first TCI state is a TCI state last activated through an MAC CE before determining the target TCI state, or a TCI state indicated through the DCI; and
the determining module further includes:
determining the BAT of the target TCI state according to the target TCI state and the first TCI state.

Further, the BAT is a first slot after Y symbols after the terminal sends response information; the response information is acknowledgment information sent by a terminal based on first information; Y is a positive integer; and the first information is information used for determining the target TCI state.

Further, the first TCI state corresponds to a first codepoint, and the target TCI state corresponds to a second codepoint;
in a case that the first TCI state and the target TCI state satisfy at least one of the following items, the terminal determines the BAT of the target TCI state;
TCI states corresponding to the first codepoint are different from TCI states corresponding to the second codepoint;
TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; and
TCI states corresponding to the first codepoint are the same as TCI states corresponding to the second codepoint, and arrangement positions of the TCI states corresponding to the first codepoint are different from arrangement positions of the TCI states corresponding to the second codepoint.

Further, TCI states corresponding to the first codepoint are different from TCI states corresponding to the second codepoint, which includes:
the TCI states corresponding to the first codepoint are different from the TCI states corresponding to the second codepoint, and the TCI states corresponding to the first codepoint are subsets of the TCI states corresponding to the second codepoint; or,
the TCI states corresponding to the first codepoint are different from the TCI states corresponding to the second codepoint, and the TCI states corresponding to the second codepoint are subsets of the TCI states corresponding to the first codepoint.

Further, the first MAC CE command includes a first signaling field, and the first signaling field is used for indicating a target TCI state from the TCI states activated by the first MAC CE command;
or, the target DCI includes a first signaling field, and the first signaling field is used for indicating a target TCI state from TCI states corresponding to codepoints indicated by a TCI field in the target DCI.

Further, whether the first MAC CE command includes a first signaling field is determined according to at least one of the following items:
configuration information of the network side device; and
a quantity of the TCI states activated by the first MAC CE command;
or, whether the target DCI includes the first signaling field is determined according to at least one of the following items:
configuration information of the network side device;
a quantity of the TCI states activated by the first MAC CE command; and
a quantity of TCI states corresponding to codepoints indicated by a TCI field in the target DCI.

Further, the first signaling field is used for indicating one of the following items:
a joint TCI state in the TCI states activated by the first MAC CE command, or a pair of separate TCI states, or a separate UL TCI state, or a separate DL TCI state;
all the TCI states activated by the first MAC CE command; and
all the TCI states activated by the first MAC CE command, and orders or positions of the various TCI states.

Or, the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; and
all the TCI states corresponding to the codepoints indicated by the TCI field in the target DCI, and orders and positions of the various TCI states.

Further, the target DCI is UL DCI.

Further, the first signaling field is an SRS resource set indicator field in the UL DCI.

Further, the UL DCI is UL DCI for scheduling uplink transmission, or UL DCI without uplink scheduling.

Further, the target TCI state includes a plurality of joint TCI states, and in a case that the plurality of joint TCI states are all associated with or contain uplink power control parameters, a TRP mode is determined as a multi-TRP scenario;
or, the target TCI state includes a plurality of separate UL TCI states, and in a case that the plurality of separate UL TCI states are all associated with or contain uplink power control parameters, a TRP mode is determined as a multi-TRP scenario;
or, in a case that a quantity of TRPs corresponding to the target TCI state indicated by the first signaling field is greater than one, a TRP mode is determined as a multi-TRP scenario;
or, in a case that a quantity of first identification information corresponding to the target TCI state indicated by the first signaling field is greater than one, a TRP mode is determined as a multi-TRP scenario, wherein the activated TCI states correspond to the first identification information.

Further, the target TCI state includes a plurality of joint TCI states, and in a case that only one of the plurality of joint TCI states is associated with or contains uplink power control parameters, a TRP mode is determined as a single TRP scenario;
or, the target TCI state includes a plurality of separate UL TCI states, and in a case that only one of the plurality of separate UL TCI states is associated with or contains uplink power control parameters, a TRP mode is determined as a single TRP scenario;
or, in a case that a quantity of TRPs corresponding to the target TCI state indicated by the first signaling field is one, a TRP mode is determined as a single TRP scenario;
or, in a case that a quantity of first identification information corresponding to the target TCI state indicated by the first signaling field is one, a TRP mode is determined as a single TRP scenario, wherein the activated TCI states correspond to the first identification information.

The second information activation apparatus 500 provided in the embodiments of this application can implement the various processes implemented by the method embodiment shown in FIG. 3 and achieve the same technical effects. To avoid repetition, details are not described here again.

The second information activation apparatus 500 in the embodiments of this application may be an electronic device, for example, an electronic device having an operating system, or a component in an electronic device, such as an integrated circuit or a chip. The electronic device may be a terminal or a device other than a terminal. Exemplarily, the terminal may include, but is not limited to, the types of the terminal 11 listed above, and the other device may be a server, a Network Attached Storage (NAS), or the like. The embodiments of this application do not impose a specific limitation on this.

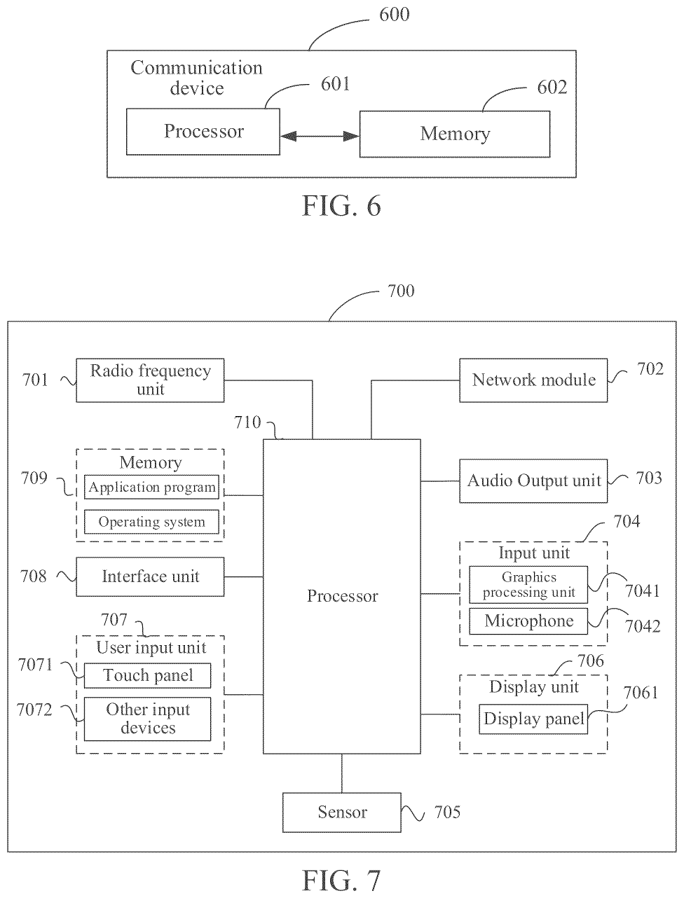

For example, as shown in FIG. 6, the embodiments of this application further provide a communication device 600, including a processor 601 and a memory 602. The memory 602 stores programs or instructions runnable on the processor 601. For example, when the communication device 600 is a terminal, the programs or instructions, when run by the processor 601, implement all the steps of the above information activation method embodiments shown in FIG. 3, and the same technical effects can be achieved. When the communication device 600 is a network side device, the programs or instructions, when run by the processor 601, implement the various processes of the above information activation method embodiment shown in FIG. 2, and the same technical effects can be achieved. To avoid repetition, details are not described here again.

The embodiments of this application further provide a terminal, including a processor and a communication interface. The communication interface is used for receiving a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels. The terminal embodiment corresponds to the terminal side method embodiment described above. All the implementation processes and implementations of the method embodiment described above can be applied to the terminal embodiment, and the same technical effect can be achieved. For example, FIG. 7 is a schematic structural diagram of hardware of a terminal for implementing the embodiments of this application.

The terminal 700 includes, but is not limited to: at least some of a radio frequency unit 701, a network module 702, an audio output unit 703, an input unit 704, a sensor 705, a display unit 706, a user input unit 707, an interface unit 708, a memory 709, a processor 710, and the like.

Those skilled in the art can understand that the terminal 700 further includes a power supply (such as a battery) for supplying power to the various components. The power supply may be logically connected to the processor 710 by using a power management system, thereby implementing functions such as charging, discharging, and power consumption management by using the power management system. The structures of the terminal shown in FIG. 7 constitute no limitation on the terminal, and the terminal may include more or fewer components than those shown in the figure, or some components may be combined, or a different component deployment may be used, details of which are omitted here.

It should be understood that in the embodiments of this application, the input unit 704 may include a Graphics Processing Unit (GPU) 7041 and a microphone 7042, and the GPU 7041 processes image data of static pictures or videos obtained by an image capturing apparatus (such as a camera) in a video capturing mode or an image capturing mode. The display unit 706 may include a display panel 7061, and the display panel 7061 may be configured by using a liquid crystal display, an organic light-emitting diode, or the like. The user input unit 707 includes at least one of a touch panel 7071 and another input device 7072. The touch panel 7071 is also referred to as a touch screen. The touch panel 7071 may include two parts: a touch detection apparatus and a touch controller. The another input device 7072 may include, but not limited to, a physical keyboard, a function key (such as a volume control key or a switch key), a track ball, a mouse, and a joystick, which is not described herein again.

In the embodiments of this application, the radio frequency unit 701 receives downlink data from a network side device and can transmit the data to the processor 710 for processing. In addition, the radio frequency unit 701 may transmit uplink data to the network side device. Generally, the radio frequency unit 701 includes, but is not limited to, an antenna, an amplifier, a transceiver, a coupler, a low noise amplifier, a duplexer, and the like.

The memory 709 is configured to store a software program or instructions and various data. The memory 709 may mainly include a first storage area for storing a program or instructions, and a second storage area for storing data. The first storage area may store an operating system, an application program or instructions required by at least one function (for example, a sound playing function and an image display function), and the like. The memory 709 may be a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in the embodiments of this application includes these and any other suitable types of memories.

The processor 710 may include one or more processing units. For example, the processor 710 may integrate an application processor and a modem processor, wherein the application processor mainly processes operations involving an operating system, a user interface, an application program, and the like, and the modem processor mainly processes a wireless communication signal, such as a baseband processor. It can be understood that, the modem processor may not be integrated into the processor 710.

The radio frequency unit 701 is configured to receive a MAC CE command, wherein the first MAC CE command is used for activating a TCI state; the first MAC CE command includes a plurality of codepoints; at least one codepoint among the plurality of codepoints corresponds to a plurality of TCI states among activated TCI states; and
the activated TCI states are used for determining common beam information of a plurality of channels.

Further, the activated TCI states correspond to first identification information; and the first identification information includes at least one of the following items:
CORESET identification information;
identification information of correlated SSs, wherein the correlated SSs are used for repeated transmission of a PDCCH;
identification information of a CORESET where the correlated SSs are located;
transmission occasion information or transmission time information of the correlated SSs;
CORESETPoolIndex;
TRP identification information;
channel group identification information;
CORESET group identification information;
PUCCH resource group identification information;
spatial filter identification information;
terminal panel identification information;
beam identification information; and
TCI state identification information.

Further, in a case that the network side device is configured with a joint TCI mode, each TCI state activated according to the first MAC CE command and the codepoints satisfy:
one codepoint corresponds to at least one joint TCI state. For example, each joint TCI state is a TCI state corresponding to one piece of the first identification information.

Further, in a case that the network side device is configured with a separate TCI mode, each TCI state activated according to the first MAC CE command and the codepoints satisfy:
one codepoint corresponds to at least one pair of separate TCI states. For example, each pair of separate TCI states is a TCI state corresponding to one piece of the first identification information.

Further, in a case that the network side device is configured with a separate TCI mode and a joint TCI mode, each TCI state activated according to the first MAC CE command and the codepoints satisfy one of the following items:
one codepoint corresponds to at least one joint TCI state and at least one pair of separate TCI state. For example, each joint TCI state corresponds to one piece of the first identification information, and each pair of separate TCI states corresponds to one piece of the first identification information.

Further, in a case that there are N pieces of first identification information corresponding to the TCI states activated according to the first MAC CE command, each piece of first identification information corresponds to one joint TCI state, or a pair of separate TCI states, or one separate DL TCI state, or one separate UL TCI state, and a value of N satisfies at least one of the following items:
the value of N is a quantity of TRPs;
the value of N is a quantity of the first identification information corresponding to the TCI states corresponding to all the codepoints in the first MAC CE command; and
the value of N is a maximum quantity of the first identification information corresponding to the joint TCI states or the separate TCI states corresponding to each codepoint in the first MAC CE command.

Further, the radio frequency unit 701 is further configured to receive target DCI, wherein the target DCI is used for indicating a target TCI state.

Further, the processor 710 is configured to determine BAT of a target TCI state among the activated TCI states.

Further, the target TCI state is a TCI state activated through the first MAC CE command, or a TCI state indicated through DCI;
a first TCI state is a TCI state last activated through an MAC CE before determining the target TCI state, or a TCI state indicated through the DCI; and

The processor 710 is further configured to: determine the BAT of the target TCI state according to the target TCI state and the first TCI state.

Further, the BAT is a first slot after Y symbols after the terminal sends response information; the response information is acknowledgment information sent by a terminal based on first information; Y is a positive integer; and the first information is information used for determining the target TCI state.

Further, the first TCI state corresponds to a first codepoint, and the target TCI state corresponds to a second codepoint;
in a case that the first TCI state and the target TCI state satisfy at least one of the following items, the BAT of the target TCI state is determined:
TCI states corresponding to the first codepoint are different from TCI states corresponding to the second codepoint;
TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; and
TCI states corresponding to the first codepoint are the same as TCI states corresponding to the second codepoint, and arrangement positions of the TCI states corresponding to the first codepoint are different from arrangement positions of the TCI states corresponding to the second codepoint.

Further, TCI states corresponding to the first codepoint are different from TCI states corresponding to the second codepoint, which includes:
the TCI states corresponding to the first codepoint are different from the TCI states corresponding to the second codepoint, and the TCI states corresponding to the first codepoint are subsets of the TCI states corresponding to the second codepoint; or,
the TCI states corresponding to the first codepoint are different from the TCI states corresponding to the second codepoint, and the TCI states corresponding to the second codepoint are subsets of the TCI states corresponding to the first codepoint.

Further, the first MAC CE command includes a first signaling field, and the first signaling field is used for indicating a target TCI state from the TCI states activated by the first MAC CE command;

Further, the target DCI includes a first signaling field, and the first signaling field is used for indicating a target TCI state from TCI states corresponding to codepoints indicated by a TCI field in the target DCI.

Further, whether the first MAC CE command includes a first signaling field is determined according to at least one of the following items:
configuration information of the network side device; and
a quantity of the TCI states activated by the first MAC CE command;

Further, whether the target DCI includes the first signaling field is determined according to at least one of the following items:
configuration information of the network side device; and
a quantity of the TCI states activated by the first MAC CE command;
a quantity of TCI states corresponding to codepoints indicated by a TCI field in the target DCI.

Further, the first signaling field is used for indicating one of the following items:
a joint TCI state in the TCI states activated by the first MAC CE command, or a pair of separate TCI states, or a separate UL TCI state, or a separate DL TCI state;
all the TCI states activated by the first MAC CE command; and
all the TCI states activated by the first MAC CE command, and orders or positions of the various TCI states.

Further, the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; and
all the TCI states corresponding to the codepoints indicated by the TCI field in the target DCI, and orders and positions of the various TCI states.

Further, the target DCI is UL DCI.

Further, the first signaling field is an SRS resource set indicator field in the UL DCI.

Further, the UL DCI is UL DCI for scheduling uplink transmission, or UL DCI without uplink scheduling.

Further, the target TCI state includes a plurality of joint TCI states, and in a case that the plurality of joint TCI states are all associated with or contain uplink power control parameters, a TRP mode is determined as a multi-TRP scenario;
or, the target TCI state includes a plurality of separate UL TCI states, and in a case that the plurality of separate UL TCI states are all associated with or contain uplink power control parameters, a TRP mode is determined as a multi-TRP scenario;
or, in a case that a quantity of TRPs corresponding to the target TCI state indicated by the first signaling field is greater than one, a TRP mode is determined as a multi-TRP scenario;
or, in a case that a quantity of first identification information corresponding to the target TCI state indicated by the first signaling field is greater than one, a TRP mode is determined as a multi-TRP scenario, wherein the activated TCI states correspond to the first identification information.

Further, the target TCI state includes a plurality of joint TCI states, and in a case that only one of the plurality of joint TCI states is associated with or contains uplink power control parameters, a TRP mode is determined as a single TRP scenario;
or, the target TCI state includes a plurality of separate UL TCI states, and in a case that only one of the plurality of separate UL TCI states is associated with or contains uplink power control parameters, a TRP mode is determined as a single TRP scenario;
or, in a case that a quantity of TRPs corresponding to the target TCI state indicated by the first signaling field is one, a TRP mode is determined as a single TRP scenario;
or, in a case that a quantity of first identification information corresponding to the target TCI state indicated by the first signaling field is one, a TRP mode is determined as a single TRP scenario, wherein the activated TCI states correspond to the first identification information.

The embodiments of this application further provide a network side device, including a processor and a communication interface. The communication interface is used for sending a first MAC CE command, wherein the first MAC CE command is used for activating a TCI state; the first MAC CE command includes a plurality of codepoints; at least one codepoint among the plurality of codepoints corresponds to a plurality of TCI states among activated TCI states; and the activated TCI states are used for determining common beam information of a plurality of channels. The network side device embodiment corresponds to the network side device method embodiment described above, and all the implementation processes and implementations of the method embodiment described above can be applied to the network side device embodiment, and the same technical effect can be achieved.

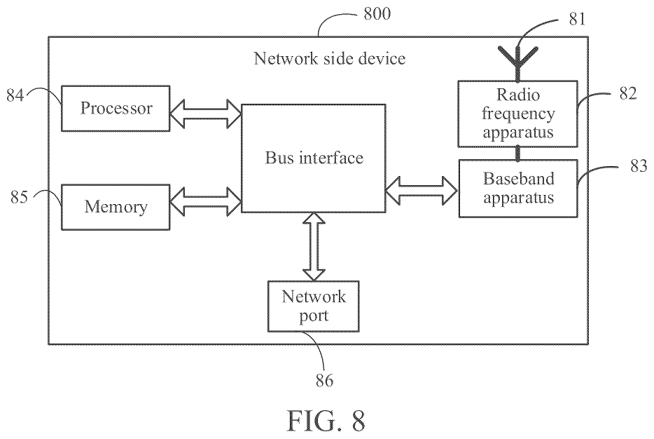

For example, the embodiments of this application further provide a network side device. As shown in FIG. 8, the network side device 800 includes: an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81 and sends the received information to the baseband apparatus 83 for processing. In a downlink direction, the baseband apparatus 83 processes information to be sent and sends the information to the radio frequency apparatus 82, and the radio frequency apparatus 82 processes the received information and sends the information via the antenna 81.

The method performed by the network side device in the above embodiment may be implemented in the baseband apparatus 83, and the baseband apparatus 83 includes a baseband processor.

The baseband apparatus 83 may include, for example, at least one baseband board. A plurality of chips are arranged on the baseband board. As shown in FIG. 8, one of the chips is, for example, a baseband processor, connected to the memory 85 through a bus interface to call a program in the memory 85 to perform the operations of the network device shown in the above method embodiment.

The network side device may further include a network interface 86. The interface is, for example, a Common Public Radio Interface (CPRI).

For example, the network side device 800 of the embodiments of this application further includes: instructions or programs stored on the memory 85 and runnable on the processor 84. The processor 84 calls the instructions or programs in the memory 85 to perform the methods performed by the various modules shown in FIG. 4 and achieve the same technical effects. To avoid repetition, details are not described here again.

The embodiments of this application further provide a readable storage medium, having programs or instructions stored thereon. The programs or instructions, when run by a processor, implement all the processes of the information activation method shown in FIG. 2 or FIG. 3 above, and the same technical effects can be achieved. To avoid repetitions, details will not be described here again.

The processor is the processor in the terminal in the embodiments described above. The readable storage medium includes a computer-readable storage medium, for example, a computer ROM, an RAM, a magnetic disc, a compact disc, or the like.

The embodiments of this application further provide a chip. The chip includes a processor and a communication interface. The communication interface is coupled to the processor. The processor is configured to run programs or instructions to implement all the processes of the information activation method embodiment shown in FIG. 2 or FIG. 3 above, and the same technical effects can be achieved. To avoid repetitions, details will not be described here again.

It should be understood that the chip mentioned in the embodiments of this application can also be referred to as a system chip, a chip system, or a system-on-chip.

The embodiments of this application further provide a computer program/program product. The computer program/program product is stored in a storage medium. The computer program/program product, when executed by at least one processor, implements all the processes of the foregoing information activation method embodiments, and the same technical effects can be achieved. To avoid repetitions, details will not be described here again.

The embodiments of this application further provide a communication system, including: a terminal and a network side device. The terminal may be configured to execute the steps of the information activation method as shown in FIG. 3 and the network side device may be configured to execute the steps of the information activation method as shown in FIG. 2.

It should be noted, the terms “include”, “comprise”, or any other variations thereof here is intended to cover a non-exclusive inclusion, so that a processor, method, object, or apparatus including a series of elements not only includes those elements, but also includes other elements not specifically listed, or includes inherent elements of this process, method, object, or apparatus. Without more limitations, elements defined by the sentence “including one” does not exclude that there are still other same elements in the process, method, object, or apparatus including these elements. In addition, it should be noted that the scope of the methods and devices in the embodiments of this application is not limited to performing functions in the order shown or discussed, but may include performing functions in a substantially simultaneous manner or in an opposite order according to the functions involved. For example, the methods described may be executed in a different order than that described, and various steps may be added, omitted, or combined. In addition, features described with reference to some examples may be combined in other examples.

According to the descriptions in the foregoing implementations, a person skilled in the art may clearly learn that the method according to the foregoing embodiment may be implemented by relying on software and an essential commodity hardware platform or by using hardware, but the former is a better implementation in most cases. Based on such an understanding, the technical solutions of this application essentially or parts contributing to the related art may be implemented in a form of a computer software product. The computer software product is stored in a storage medium (such as a ROM/RAM, a magnetic disk, or a CD) and includes several instructions for instructing a terminal (which may be a mobile phone, a computer, a server, an air conditioner, a network device, or the like) to perform the methods described in the various embodiments of this application.

The embodiments of this application have been described above with reference to the accompanying drawings. This application is not limited to the implementations described above, and the implementations described above are merely examples and not limitative. Those of ordinary skill in the art may make various forms under the teaching of this application without departing from the spirit of this application and the protection scope of the claims, and these forms shall all fall within the protection of this application.

What is claimed is:

1. An information activation method, comprising:
sending, by a network side device, a first Media Access Control Control Element (MAC CE) command, wherein the first MAC CE command is used for activating a Transmission Configuration Indicator (TCI) state,
wherein:
the first MAC CE command comprises a plurality of codepoints,
at least one codepoint among the plurality of codepoints corresponds to a plurality of TCI states among activated TCI states, and
the activated TCI states are used for determining common beam information of a plurality of channels.

2. The information activation method according to claim 1, wherein the activated TCI states correspond to first identification information; and the first identification information comprises at least one of the following items:
Control Resource Set (CORESET) identification information;
identification information of correlated Search Spaces (SSs), wherein the correlated SSs are used for repeated transmission of a Physical Downlink Control Channel (PDCCH);
identification information of a CORESET where the correlated SSs are located;
transmission occasion information or transmission time information of the correlated SSs;
CORESET Pool Index (CORESETPoolIndex);
Transmission Reception Point (TRP) identification information;
channel group identification information;
CORESET group identification information;
Physical Uplink Control Channel (PUCCH) resource group identification information;
spatial filter identification information;
terminal panel identification information;
beam identification information; or
TCI state identification information.

3. The information activation method according to claim 1, wherein when the network side device is configured with a joint TCI mode, each TCI state activated according to the first MAC CE command and the codepoints satisfy:
one codepoint corresponds to at least one joint TCI state.

4. The information activation method according to claim 1, wherein when the network side device is configured with a separate TCI mode, each TCI state activated according to the first MAC CE command and the codepoints satisfy:
one codepoint corresponds to at least one pair of separate TCI states.

5. The information activation method according to claim 1, wherein when the network side device is configured with a separate TCI mode and a joint TCI mode, each TCI state activated according to the first MAC CE command and the codepoints satisfy one of the following items:
one codepoint corresponds to at least one joint TCI state or at least one pair of separate TCI state.

6. The information activation method according to claim 2, wherein when there are N pieces of first identification information corresponding to the TCI states activated according to the first MAC CE command, each piece of first identification information corresponds to one joint TCI state, or a pair of separate TCI states, or one separate Downlink (DL) TCI state, or one separate Uplink (UL) TCI state, and a value of N satisfies at least one of the following items:
the value of N is a quantity of TRPs;
the value of N is a quantity of the first identification information corresponding to the TCI states corresponding to all the codepoints in the first MAC CE command; or
the value of N is a maximum quantity of the first identification information corresponding to the joint TCI states or the separate TCI states corresponding to each codepoint in the first MAC CE command.

7. The information activation method according to claim 1, further comprising:
sending, by the network side device, target Downlink Control Information (DCI), wherein the target DCI is used for indicating a target TCI state from the activated TCI states.

8. The information activation method according to claim 1, further comprising:
determining, by the network side device, Beam Application Time (BAT) of a target TCI state among the activated TCI states.

9. The information activation method according to claim 8,
wherein:
the target TCI state is a TCI state activated by the network side device through the first MAC CE command, or a TCI state indicated through DCI;
a first TCI state is a TCI state last activated by the network side device through an MAC CE before determining the target TCI state, or a TCI state indicated through the DCI; and
determining, by the network side device, the BAT of the target TCI state among the activated TCI states comprises:
determining, by the network side device, the BAT of the target TCI state according to the target TCI state and the first TCI state.

10. The information activation method according to claim 8,
wherein:
the BAT is a first slot after Y symbols after the network side device receives response information;
the response information is acknowledgment information sent by a terminal based on first information;
Y is a positive integer; and
the first information is information used for determining the target TCI state.

11. The information activation method according to claim 9,
wherein:
the first TCI state corresponds to a first codepoint, and the target TCI state corresponds to a second codepoint;
when the first TCI state and the target TCI state satisfy at least one of the following items, the network side device determines the BAT of the target TCI state:
TCI states corresponding to the first codepoint are different from TCI states corresponding to the second codepoint;
TCI states corresponding to the first codepoint are the same as TCI states corresponding to the second codepoint, and an arrangement sequence of the TCI states corresponding to the first codepoint is different from an arrangement sequence of the TCI states corresponding to the second codepoint; or
TCI states corresponding to the first codepoint are the same as TCI states corresponding to the second codepoint, and arrangement positions of the TCI states corresponding to the first codepoint are different from arrangement positions of the TCI states corresponding to the second codepoint.

12. The information activation method according to claim 11, wherein TCI states corresponding to the first codepoint are different from TCI states corresponding to the second codepoint, comprising:
the TCI states corresponding to the first codepoint are different from the TCI states corresponding to the second codepoint, and the TCI states corresponding to the first codepoint are subsets of the TCI states corresponding to the second codepoint; or,
the TCI states corresponding to the first codepoint are different from the TCI states corresponding to the second codepoint, and the TCI states corresponding to the second codepoint are subsets of the TCI states corresponding to the first codepoint.

13. The information activation method according to claim 1, wherein the first MAC CE command comprises a first signaling field, and the first signaling field is used for indicating a target TCI state from the TCI states activated by the first MAC CE command.

14. The information activation method according to claim 7, wherein the target DCI comprises a first signaling field, and the first signaling field is used for indicating a target TCI state from TCI states corresponding to codepoints indicated by a TCI field in the target DCI.

15. The information activation method according to claim 1, wherein whether the first MAC CE command comprises a first signaling field is determined according to at least one of the following items:
configuration information of the network side device; or
a quantity of the TCI states activated by the first MAC CE command.

16. The information activation method according to claim 7, wherein whether the target DCI comprises a first signaling field is determined according to at least one of the following items:
configuration information of the network side device;
a quantity of the TCI states activated by the first MAC CE command; or
a quantity of TCI states corresponding to codepoints indicated by a TCI field in the target DCI.

17. The information activation method according to claim 13, wherein the first signaling field is used for indicating one of the following items:
a joint TCI state in the TCI states activated by the first MAC CE command, or a pair of separate TCI states, or a separate Uplink (UL) TCI state, or a separate Downlink (DL) TCI state;
all the TCI states activated by the first MAC CE command; or
all the TCI states activated by the first MAC CE command, and orders or positions of the various TCI states.

18. The information activation method according to claim 14, wherein the first signaling field is used for indicating one of the following items:
a joint TCI state in the TCI states corresponding to the codepoints indicated by the TCI field in the DCI, or a pair of separate TCI states, or a separate UL TCI state, or a separate DL TCI state;
all the TCI states corresponding to the codepoints indicated by the TCI field in the target DCI; or
all the TCI states corresponding to the codepoints indicated by the TCI field in the target DCI, and orders and positions of the various TCI states.

19. A network side device, comprising: a processor; and a memory having a computer program or an instruction stored thereon, wherein the computer program or instruction, when executed by the processor, causes the processor to implement operations, comprising:
sending a first Media Access Control Control Element (MAC CE) command, wherein the first MAC CE command is used for activating a Transmission Configuration Indicator (TCI) state,
wherein:
the first MAC CE command comprises a plurality of codepoints,
at least one codepoint among the plurality of codepoints corresponds to a plurality of TCI states among activated TCI states, and
the activated TCI states are used for determining common beam information of a plurality of channels.

20. A non-transitory computer-readable storage medium storing a computer program or an instruction that, when executed by a processor, causes the processor to implement operations, comprising:
sending a first Media Access Control Control Element (MAC CE) command, wherein the first MAC CE command is used for activating a Transmission Configuration Indicator (TCI) state,
wherein:
the first MAC CE command comprises a plurality of codepoints,
at least one codepoint among the plurality of codepoints corresponds to a plurality of TCI states among activated TCI states, and
the activated TCI states are used for determining common beam information of a plurality of channels.
